(19) United States
(12) Patent Application Publication
(10) Pub. No.: US 2025/0206938 A1
(43) Pub. Date: Jun. 26, 2025

(54) COMPOSITE MATERIAL AND METHOD FOR PRODUCING SAME, AND CROSSLINKING AGENT

(71) Applicants: OSAKA UNIVERSITY, Suita-shi (JP); YUSHIRO CHEMICAL INDUSTRY CO., LTD., Tokyo (JP)

(72) Inventors: Yoshinori Takashima, Suita-shi (JP); Akira Harada, Suita-shi (JP); Junsu Park, Suita-shi (JP); Yusaku Kawai, Suita-shi (JP); Changming Jin, Suita-shi (JP); Yasumasa Ohashi, Koza-gun (JP); Hiroaki Takahashi, Koza-gun (JP); Motofumi Osaki, Koza-gun (JP); Kazuya Takahashi, Koza-gun (JP); Hidenori Shirakawa, Koza-gun (JP)

(73) Assignees: OSAKA UNIVERSITY, Suita-shi (JP); YUSHIRO CHEMICAL INDUSTRY CO., LTD., Tokyo (JP)

(21) Appl. No.: 18/850,796

(22) PCT Filed: Mar. 28, 2023
(86) PCT No.: PCT/JP2023/012683

§ 371 Date: Sep. 25, 2024

(30) Foreign Application Priority Data
Mar. 29, 2022 (JP) 2022-054198

(51) Int. Cl. C08L 33/12; C08F 2/44; C08F 2/50; C08F 120/14; C08F 220/14; C08F 251/02

(52) U.S. Cl. CPC C08L 33/12; C08F 2/44; C08F 2/50; C08F 120/14; C08F 220/14; C08F 251/02; C08L 2205/04; C08L 2312/06

(57) ABSTRACT

Provided is a composite material that can be produced by a simple method and has excellent mechanical properties, and a method for producing the same. The composite material of the present invention comprises a cyclic molecular multimer having at least two host groups, and a polymer component, the host groups each being a group formed by removing one hydrogen atom or hydroxy group from a cyclodextrin or a cyclodextrin derivative, and the cyclic molecular multimer having a structure formed such that the at least two host groups are linked via a divalent or higher group having a chain structure.

### TECHNICAL FIELD

The present invention relates to a composite material and a method for producing the same, as well as a crosslinking agent.

### BACKGROUND ART

Macromolecular materials are widely used in, for example, films, adhesives, coating agents, molding materials, and paints, and are indispensable functional materials in the fields of electronic components, automobile components, packaging materials, and the like. Particularly in recent years, there has been a demand in various fields for products with higher performance and precision, resulting in a demand for macromolecular materials with even higher performance and functionality. Thus, research and development of various new macromolecular materials is being actively conducted. In particular, improving the hardness, elongation, and fracture resistance energy of macromolecular materials is extremely important from the viewpoint of improving product performance and life, reducing environmental load, and utilizing resources.

As one of the means for improving the performance of macromolecular materials, a method of forming a macromolecular composite material by mixing a base macromolecular compound with an additive, such as an inorganic filler or a rubber component, is generally known. In addition, in order to provide a macromolecular material having high mechanical strength etc., for example, PTL 1 or PTL 2 proposes a technique for precisely controlling a macromolecular structure by utilizing host-guest interaction through a clathrate complex.

### CITATION LIST

### Patent Literature

PTL 1: WO2016/163550
PTL 2: WO2018/159791

### SUMMARY OF INVENTION

### Technical Problem

Although the above macromolecular composite materials containing an inorganic filler etc. or macromolecular composite materials having host-guest interaction have a certain level of mechanical strength, in recent years, there has been an increasing demand for improved mechanical properties for macromolecular materials in various fields. From this perspective, there is an urgent need to develop technology to further improve the mechanical properties of macromolecular materials.

The present invention was made in view of these circumstances in the art. An object of the invention is to provide a composite material that can be produced by a simple method and has excellent mechanical properties, and a method for producing the same. Another object of the present invention is to provide a crosslinking agent that can be suitably used for producing the composite material.

### Solution to Problem

The present inventors conducted extensive research to achieve the above objects, and found that the above objects can be achieved by using a cyclic molecular multimer. The present invention has been accomplished based on this finding.

Specifically, the present invention includes, for example, the subject matter described in the following items.

### Item 1.

A composite material comprising a cyclic molecular multimer having at least two host groups, and a polymer component,
the host groups each being a group formed by removing one hydrogen atom or hydroxy group from a cyclodextrin or a cyclodextrin derivative, and
the cyclic molecular multimer having a structure formed such that the at least two host groups are linked via a divalent or higher group having a chain structure.

### Item 2.

The composite material according to Item 1, wherein the cyclodextrin derivative has a structure formed such that a hydrogen atom of at least one hydroxy group contained in a cyclodextrin is replaced with at least one group selected from the group consisting of a hydrocarbon group, an acyl group, and —CONHR wherein R represents an alkyl group.

### Item 3.

The composite material according to Item 1 or 2, comprising a crosslinked structure formed such that the polymer component is crosslinked with the cyclic molecular multimer.

### Item 4.

The composite material according to Item 1 or 2, wherein the polymer component comprises a guest polymer having at least one guest group on a polymer side chain, and the composite material comprises a crosslinked structure formed such that at least one host group in the cyclic molecular multimer forms a clathrate complex together with the guest group in the guest polymer, and the other host group forms a clathrate complex together with a guest group in another guest polymer.

### Item 5.

The composite material according to Item 1 or 2, wherein the polymer component comprises a first linear polymer, and the composite material comprises a crosslinked structure formed such that the first linear polymer penetrates at least one host group in the cyclic molecular multimer, and another first linear polymer penetrates the other host group.

### Item 6.

The composite material according to Item 5, wherein the polymer component comprises a second linear polymer, and the second linear polymer penetrates a network of the crosslinked structure.

### Item 7.

A crosslinking agent for forming a crosslinked structure of a polymer,
the crosslinking agent comprising a cyclic molecular multimer,
the cyclic molecular multimer having at least two host groups,
the host groups each being a group formed by removing one hydrogen atom or hydroxy group from a cyclodextrin or a cyclodextrin derivative, and
the cyclic molecular multimer having a structure formed such that the at least two host groups are linked via a divalent or higher group having a chain structure.

### Item 8.

The cyclic molecular multimer according to Item 7, wherein the cyclodextrin derivative has a structure formed such that a hydrogen atom of at least one hydroxy group contained in a cyclodextrin is replaced with at least one group selected from the group consisting of a hydrocarbon group, an acyl group, and —CONHR wherein R represents an alkyl group.

### Item 9.

A method for producing the composite material according to any one of Items 1 to 6, comprising obtaining the composite material from a mixture of the cyclic molecular multimer and a polymer component.

### Item 10.

A method for producing the composite material according to any one of Items 1 to 6, comprising performing a polymerization reaction of a polymerizable monomer in the presence of the cyclic molecular multimer to produce a polymer component, thereby obtaining the composite material.

### Advantageous Effects of Invention

The composite material of the present invention can be produced by a simple method and has excellent mechanical properties.

### BRIEF DESCRIPTION OF DRAWINGS

FIG. 1 is a schematic diagram schematically showing a crosslinked structure having a structure formed such that guest polymers are crosslinked with a cyclic molecular multimer.

FIG. 2 is a schematic diagram schematically showing a crosslinked structure having a structure formed such that first linear polymers are crosslinked with a cyclic molecular multimer.

FIG. 3 shows a reaction scheme for producing a cyclic molecular multimer.

FIG. 4 shows the ¹H-NMR spectrum of the cyclic molecular multimer obtained in Production Example 2.

FIG. 5 shows the results of GPC measurement of the cyclic molecular multimer obtained in Production Example 2.

FIG. 6 shows the stress-strain curves and the results of Young's modulus and fracture energy of the composite materials obtained in Examples 1-1, 1-2, and 1-3.

FIG. 7 shows the stress-strain curves and the results of Young's modulus and fracture energy of the composite materials obtained in Example 2-1 and Comparative Example 2-1.

FIG. 8 shows the results of Young's modulus and fracture energy of the composite materials obtained in Example 3-1 and Comparative Example 3-1.

FIG. 9 shows the stress-strain curves and the results of Young's modulus and fracture energy of the composite materials obtained in Examples 4-1, 4-2, and 4-3 and Comparative Example 4-1.

FIG. 10 shows the stress-strain curves and the results of Young's modulus and fracture energy of the composite materials obtained in Example 5-1 and Comparative Example 5-1.

### DESCRIPTION OF EMBODIMENTS

The following describes embodiments of the present invention in detail. In the present specification, the terms “comprise,” “contain,” and “include” include the concepts of “comprise,” “consist essentially of,” and “consist of.”

### 1. Composite Material

The composite material of the present invention contains a cyclic molecular multimer having at least two host groups, and a polymer component. The host group is a group formed by removing one hydrogen atom or hydroxy group from a cyclodextrin or a cyclodextrin derivative. Further, the cyclic molecular multimer has a structure formed such that the at least two host groups are linked via a divalent or higher group having a chain structure.

The composite material of the present invention is a polymer-based composite material (macromolecular composite material), can be produced by a simple method, and has excellent mechanical properties. In particular, the composite material of the present invention has high fracture energy.

### Cyclic Molecular Multimer

The cyclic molecular multimer contained in the composite material of the present invention is a compound having at least two host groups, and has a structure formed such that the at least two host groups are linked via a divalent or higher group having a chain structure. The cyclic molecular multimer contained in the composite material of the present invention is referred to below as “cyclic molecular multimer C.”

In cyclic molecular multimer C, the host group is a group formed by removing one hydrogen atom or hydroxy group from a cyclodextrin or a cyclodextrin derivative.

The cyclodextrin derivative refers to one with a structure formed such that the hydrogen atom of at least of the hydroxy groups contained in a cyclodextrin is replaced with a hydrophobic group. That is, the cyclodextrin derivative refers to a molecule with a structure formed such that a cyclodextrin molecule is replaced with a different organic hydrophobic group. However, the cyclodextrin derivative has at least one hydrogen atom or at least one hydroxy group, and preferably has at least one hydroxy group.

The hydrophobic group is preferably at least one group selected from the group consisting of a hydrocarbon group, an acyl group, and —CONHR wherein R represents a methyl group or an ethyl group. In the present specification, “at least one group selected from the group consisting of a hydrocarbon group, an acyl group, and —CONHR wherein R represents a methyl group or an ethyl group” may be referred to below as “a hydrocarbon group etc.” for convenience.

Just to note, the term “cyclodextrin” in the present specification refers to at least one member selected from the group consisting of α-cyclodextrin, β-cyclodextrin, and γ-cyclodextrin. Therefore, the cyclodextrin derivative is at least one member selected from the group consisting of α-cyclodextrin derivatives, β-cyclodextrin derivatives, and γ-cyclodextrin derivatives.

The host group is a monovalent or higher group formed by removing one hydrogen atom or hydroxy group from a cyclodextrin derivative. The hydrogen atom or hydroxy group removed from the cyclodextrin derivative may be at any position of the cyclodextrin or cyclodextrin derivative.

When the total number of hydroxy groups in a single molecule of a cyclodextrin is N, N of α-cyclodextrin is 18, N of β-cyclodextrin is 21, and N of γ-cyclodextrin is 24.

If the host group is a monovalent group formed by removing one “hydroxy group” from a cyclodextrin derivative, the maximum number of hydroxy groups whose hydrogens can be replaced with a hydrocarbon group etc. is N-1 per molecule of the cyclodextrin. If the host group is a monovalent group formed by removing one “hydrogen atom” from a cyclodextrin derivative, the maximum number of hydroxy groups whose hydrogens can be replaced with a hydrocarbon group etc. is N per molecule of the cyclodextrin.

When the host group is a group formed by removing one hydrogen atom or hydroxy group from a cyclodextrin derivative, the host group preferably has a structure such that the hydrogen atoms of at least 70%, more preferably at least 80%, and particularly preferably at least 90%, of the total number of hydroxy groups per molecule of the cyclodextrin are replaced with a hydrocarbon group etc.

When the host group is a group formed by removing one hydrogen atom or hydroxy group from a cyclodextrin derivative, the host group preferably has a structure such that the hydrogen atoms of at least 13 hydroxy groups, more preferably at least 15 hydroxy groups, and particularly preferably at least 17 hydroxy groups, out of the total number of hydroxy groups per molecule of α-cyclodextrin are replaced with a hydrocarbon group etc.

The host group preferably has a structure such that the hydrogen atoms of at least 15 hydroxy groups, more preferably at least 17 hydroxy groups, and particularly preferably at least 19 hydroxy groups, out of the total number of hydroxy groups per molecule of β-cyclodextrin are replaced with a hydrocarbon group etc.

The host group preferably has a structure such that the hydrogen atoms of at least 17 hydroxy groups, more preferably at least 19 hydroxy groups, and particularly preferably at least 21 hydroxy groups, out of the total number of hydroxy groups per molecule of γ-cyclodextrin are replaced with a hydrocarbon group etc.

In the cyclodextrin derivative, the type of the hydrocarbon group is not particularly limited. Examples of the hydrocarbon group include an alkyl group, an alkenyl group, and an alkynyl group.

The number of carbon atoms of the hydrocarbon group is not particularly limited. For example, the number of carbon atoms of the hydrocarbon group is preferably 1 to 4.

Specific examples of hydrocarbon groups having 1 to 4 carbon atoms include a methyl group, an ethyl group, an n-propyl group, an isopropyl group, and a butyl group. When the hydrocarbon group is a propyl group or a butyl group, the hydrocarbon group may be linear or branched.

In the cyclodextrin derivative, examples of the acyl group include an acetyl group, a propionyl group, and a formyl group. The acyl group is preferably an acetyl group because host-guest interaction easily occurs, another polymer chain can easily penetrate the ring of the host group, and a macromolecular material excellent in toughness and strength can be easily obtained.

In the cyclodextrin derivative, —CONHR wherein R represents a methyl group or an ethyl group is a methyl carbamate group or an ethyl carbamate group. —CONHR is preferably an ethyl carbamate group because host-guest interaction easily occurs, another polymer chain can easily penetrate the ring of the host group, and a macromolecular material excellent in toughness and strength can be easily obtained.

In the cyclodextrin derivative, the hydrocarbon group is preferably a C₁₋₄ alkyl group or acyl group, preferably a methyl group or an acyl group, more preferably a methyl group, an acetyl group, or a propionyl group, and particularly preferably a methyl group or an acetyl group.

As described above, cyclic molecular multimer C has a divalent or higher group having a chain structure. This group is referred to below as a “linking group.” The linking group is for linking the at least two host groups. The linking group is divalent or higher, preferably tetravalent or less, and more preferably divalent.

The type of linking group is not particularly limited. The linking group may be linear or branched.

The molecular weight of the linking group is preferably 12 or more, preferably 50 or more, and more preferably 100 or more, and is preferably 10000 or less, more preferably 3000 or less, even more preferably 1000 or less, and particularly preferably 500 or less.

The terminal portion of the linking group is bonded to a host group. For example, when the linking group is divalent, both terminals of the linking group are bonded to host groups. The bond between the linking group and the host group is a chemical bond, and generally a covalent bond.

Cyclic molecular multimer C can be represented, for example, by the following formula (1):

R¹—(R^{H})ₙ (1)

In formula (1), R¹ represents a linking group, R^{H} represents the host group, and n is an integer of 2 to 4. In the compound represented by formula (1), n R^{H}s are covalently bonded to R¹. The host group R^{H} in the host group-containing polymerizable monomer represented by formula (1) is an example of a monovalent group formed by removing one hydroxy group from a cyclodextrin or a derivative thereof.

When R¹ is a divalent linking group, cyclic molecular multimer C can be represented by the following formula (1a):

R^{H}—R¹—R^{H} (1a)

In formula (1a), R¹ represents a linking group, and R^{H} represents the host group. The host group R^{H} in the host group-containing polymerizable monomer represented by formula (1a) is an example of a monovalent group formed by removing one hydroxy group from a cyclodextrin or a derivative thereof.

The linking group (R¹) can have, for example, an alkylene group, an ether group, a thioether group, an amino group, a disulfide group, or the like. The number of carbon atoms of the alkylene group is, for example, preferably 1 or more, and more preferably 2 or more, and is preferably 20 or less, more preferably 15 or less, and even more preferably 10 or less. The linking group (R¹) preferably has at least an alkylene group.

More specifically, the linking group (R¹) may have one or more groups selected from an alkylene group having 1 to 5 carbon atoms, an ether group (—O—), and a thioether group (—S—). The linking group (R¹) may also comprise all of these groups. For example, the linking group (R¹) can have a group represented by the following formula (2):

—(CₘH₂ₘ)ₖ—S—{(CₘH₂ₘ)ₗ—O}ₐ—(CₘH₂ₘ)_{b}—S—(CₘH₂ₘ)_{c}— (2)

In formula (2), m is an integer of 1 to 5, preferably 2 to 4, and more preferably 2. In formula (2), k is an integer of 1 to 5, preferably 1 to 3, and more preferably 1. In formula (2), l is an integer of 1 to 5, preferably 1 to 3, and more preferably 1. In formula (2), a is an integer of 1 to 5, preferably 1 to 3, and more preferably 2. In formula (2), b is an integer of 1 to 5, preferably 1 to 3, and more preferably 1. In formula (2), c is an integer of 1 to 5, preferably 1 to 3, and more preferably 1.

The type of the terminal portion of the linking group (R¹) is not particularly limited as long as it is a group that can bind to a host group. Examples include a divalent group formed by removing one hydrogen atom from a monovalent group selected from the group consisting of a hydroxy group, a thiol group, an alkoxy group optionally having at least one substituent, a thioalkoxy group optionally having at least one substituent, an alkyl group optionally having at least one substituent, an amino group optionally having one substituent, an amide group optionally having one substituent, an aldehyde group, and a carboxy group.

In formulas (1) and (1a), the substituents are not particularly limited, and examples include an alkyl group having 1 to 20 carbon atoms, an alkenyl group having 2 to 20 carbon atoms, an alkynyl group having 2 to 20 carbon atoms, a halogen atom, a carboxy group, a carbonyl group, a sulfonyl group, a sulfone group, and a cyano group.

In formulas (1) and (1a), when the terminal of R¹ is a divalent group formed by removing one hydrogen atom from an amide group optionally having one substituent, the nitrogen atom of the amide group can bind to R^{H}.

In formulas (1) and (1a), when the terminal of R¹ is a divalent group formed by removing one hydrogen atom from a carboxy group, the oxygen atom of the carboxy group can bind to R^{H}.

The terminal portion of the linking group (R¹) is preferably a divalent group formed by removing one hydrogen atom from an amide group optionally having one substituent, and preferably a divalent group formed by removing one hydrogen atom from an amide group having no substituent (i.e., —CONH—). In this case, the terminal portion of the linking group (R¹) is —CONH—.

The terminal portions of the linking group (R¹) may all be the same or different. For example, when the linking group (R¹) is a divalent group, both terminals may be the same or different.

When the linking group (R¹) has a group represented by formula (2), for example, the terminal portions of the linking group (R¹) directly bind to both terminals of the group represented by formula (2). For example, when the terminal portion of the linking group (R¹) is R¹—CONH—, R¹ represented by formula (1a) is represented by the following formula (2a):

—NHCO—(CₘH₂ₘ)ₖ—S—{(CₘH₂ₘ)ₗ—O}ₐ—(CₘH₂ₘ)_{b}—S—(CₘH₂ₘ)_{c}—CONH— (2a)

In cyclic molecular multimer C, the number of host groups is 2 or more, preferably 4 or less, more preferably 3 or less, and even more preferably 2.

The method for producing cyclic molecular multimer C is not particularly limited, and can be selected from a wide range of known production methods.

For example, cyclic molecular multimer C can be produced by a reaction between acrylated cyclodextrin and a dithio compound having thiol groups at both ends, i.e., the so-called thiol-ene reaction.

The acrylated cyclodextrin is, for example, a cyclodextrin compound having a structure formed such that one hydroxy group of a cyclodextrin or a derivative thereof is replaced with a (meth)acrylic compound. An example of the (meth)acrylic compound is acrylamide. In this case, the acrylated cyclodextrin is a cyclodextrin compound having a structure formed such that one hydroxy group of a cyclodextrin or a derivative thereof is replaced with acrylamide (CH₂═CHCONH—). An example of the acrylated cyclodextrin is 6-acrylamide cyclodextrin. The acrylated cyclodextrin can be obtained by a known method.

In the present specification, “(meth)acrylic” means “acrylic” or “methacrylic,” “(meth)acrylate” means “acrylate” or “methacrylate,” and “(meth)allyl” means “allyl” or “methallyl.”

The dithio compound is, for example, a compound represented by the following formula (3):

HS—{(CₘH₂ₘ)ₗ—O}ₐ—(CₘH₂ₘ)_{b}—SH (3)

In formula (3), m, l, a, and b are respectively the same as m, 1, a, and b in formula (2).

Examples of the dithio compound include 3,6-dioxa-1,8-octanedithiol.

The method of the thiol-ene reaction is not particularly limited. For example, a method similar to a known thiol-ene reaction can be used in the present invention. Examples include a method of irradiating a mixture of the acrylated cyclodextrin and the dithio compound with ultraviolet rays, and a method of reacting the acrylated cyclodextrin with the dithio compound in the presence of an azo compound.

### Polymer Component

Examples of the polymer component contained in the composite material of the present invention include a wide range of known macromolecular compounds. The polymer component is preferably a polymer that can form a crosslinked structure by crosslinking with cyclic molecular multimer C. That is, the composite material of the present invention preferably contains a crosslinked structure in which the polymer component is crosslinked with the cyclic molecular multimer.

Examples of the polymer component that can form the crosslinked structure include guest polymers and first linear polymers.

### Guest Polymer

The guest polymer may be a macromolecular compound having at least one guest group on a polymer side chain. Examples of the guest polymer include a wide range of known guest polymers.

The type of guest group is not limited as long as it is a group capable of host-guest interaction with the host group, particularly as long as it is a group that can be included in the host group. The guest group is not limited to a monovalent group, but may be a divalent group, for example. Furthermore, a guest group-containing monomer unit may contain only one guest group, or may contain two or more guest groups.

Examples of the guest group include linear or branched hydrocarbon groups having 3 to 30 carbon atoms, cycloalkyl groups, heteroaryl groups, and organometallic complexes, each of which may have at least one substituent. The substituents are the same as those described above, and examples include halogen atoms (e.g., fluorine, chlorine, and bromine), hydroxy groups, carboxy groups, ester groups, amide groups, and optionally protected hydroxy groups.

More specific examples of the guest group include a chain or cyclic alkyl group having 4 to 18 carbon atoms and a group derived from a polycyclic aromatic hydrocarbon. The chain alkyl group having 4 to 18 carbon atoms may be either linear or branched. The cyclic alkyl group may have a cage structure. Examples of polycyclic aromatic hydrocarbons include I-conjugated compounds formed of at least two aromatic rings, and specific examples include naphthalene, anthracene, tetracene, pentacene, benzopyrene, chrysene, pyrene, triphenylene, and the like.

Other examples of the guest group include monovalent groups formed by removing one atom (e.g., a hydrogen atom) from a guest molecule, such as at least one selected from the group consisting of alcohol derivatives, aryl compounds, carboxylic acid derivatives, amino derivatives, azobenzene derivatives having a cyclic alkyl group or a phenyl group, cinnamic acid derivatives, aromatic compounds and alcohol derivatives thereof, amine derivatives, ferrocene derivatives, azobenzene, naphthalene derivatives, anthracene derivatives, pyrene derivatives, perylene derivatives, clusters composed of carbon atoms such as fullerene, and dansyl compounds.

Further specific examples of the guest group include a t-butyl group, an n-octyl group, an n-dodecyl group, an isobornyl group, an adamantyl group, a group derived from pyrene, and groups in which the substituents mentioned above are bonded to these groups.

The guest polymer may contain only one type of guest group, or two or more types of guest groups.

The guest polymer may be, for example, a copolymer of a polymerizable monomer having the guest group (guest group-containing monomer unit) and a polymerizable monomer having no guest group.

The guest group-containing monomer unit is not particularly limited as long as it is a polymerizable compound having the guest group. Examples include a wide range of known guest group-containing polymerizable monomers. The guest group-containing polymerizable monomer preferably has a radically polymerizable functional group. Examples of the radically polymerizable functional group include a group containing a carbon-carbon double bond, and specific examples include an acryloyl group (CH₂═CH(CO)—), a methacryloyl group (CH₂═CCH₃(CO)—), a styryl group, a vinyl group, an allyl group, and the like. These groups containing a carbon-carbon double bond may further have a substituent as long as the radical polymerizability is not inhibited.

Specific examples of the guest group-containing polymerizable monomer include vinyl polymerizable monomers having the guest group. For example, the guest group-containing polymerizable monomer may be a compound represented by the following formula (g1):

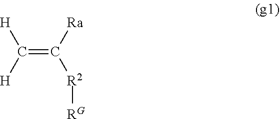

In formula (g1), Ra represents a hydrogen atom or a methyl group, R^{G} represents the guest group, and R² represents a divalent group formed by removing one hydrogen atom from a monovalent group selected from the group consisting of a hydroxy group, a thiol group, an alkoxy group optionally having at least one substituent, a thioalkoxy group optionally having at least one substituent, an alkyl group optionally having at least one substituent, an amino group optionally having one substituent, an amide group optionally having one substituent, an aldehyde group, and a carboxy group.

Among the polymerizable monomers represented by formula (g1), preferred is a (meth)acrylic acid ester or a derivative thereof (i.e., R² is —COO—), or (meth)acrylamide or a derivative thereof (i.e., R² is —CONH— or —CONR—, and R has the same meaning as the above substituent). In this case, the polymerization reaction proceeds easily, facilitating the production of polymer A.

Specific examples of the guest group-containing polymerizable monomer include n-hexyl (meth)acrylate, n-octyl (meth)acrylate, n-dodecyl (meth)acrylate, adamantyl (meth)acrylate, hydroxyadamantyl (meth)acrylate, 1-(meth)acrylamide adamantane, 2-ethyl-2-adamantyl (meth)acrylate, N-dodecyl (meth)acrylamide, t-butyl (meth)acrylate, 1-acrylamide adamantane, N-(1-adamantyl)(meth)acrylamide, N-benzyl (meth)acrylamide, N-1-naphthylmethyl (meth)acrylamide, ethoxylated o-phenylphenol acrylate, phenoxy polyethylene glycol acrylate, isostearyl acrylate, nonylphenol EO adduct acrylate, isobornyl (meth)acrylate, (meth)acrylate having a pyrene moiety, and (meth)acrylamide having a pyrene moiety.

The guest group-containing polymerizable monomer can be produced by a known method. Further, the guest group-containing polymerizable monomer may be a commercially available product.

The type of polymerizable monomer having no guest group is not particularly limited, and examples include a wide range of known polymerizable monomers. The polymerizable monomer having no guest group is referred to below as “the third polymerizable monomer.” The third polymerizable monomer preferably does not have a host group either.

Examples of the third polymerizable monomer include various known vinyl polymerizable monomers. Specific examples of the third polymerizable monomer include a compound represented by the following formula (a1):

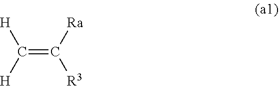

In formula (a1), Ra represents a hydrogen atom or a methyl group, and R³ represents a halogen atom, a hydroxy group, a thiol group, an amino group optionally having one substituent or a salt thereof, a carboxy group optionally having one substituent or a salt thereof, an amide group optionally having at least one substituent or a salt thereof, or a phenyl group optionally having at least one substituent.

When R³ in formula (a1) is a carboxy group having one substituent, examples of the carboxy group include those whose hydrogen atom is replaced with a hydrocarbon group having 1 to 20 carbon atoms, a hydroxyalkyl group (e.g., a hydroxymethyl group, a 1-hydroxyethyl group, and a 2-hydroxyethyl group), methoxy polyethylene glycol (the number of units of ethylene glycol is 1 to 20, preferably 1 to 10, and particularly preferably 2 to 5), ethoxy polyethylene glycol (the number of units of ethylene glycol is 1 to 20, preferably 1 to 10, and particularly preferably 2 to 5), or the like (i.e., esters). The hydrocarbon group having 1 to 20 carbon atoms preferably has 1 to 15 carbon atoms, more preferably 1 to 10 carbon atoms, and particularly preferably 1 to 3 carbon atoms. The hydrocarbon group may be linear or branched.

When R³ in formula (a1) is an amide group having at least one substituent (i.e., a secondary amide or tertiary amide), examples of the amide group include those formed such that one hydrogen atom or two hydrogen atoms of the primary amide are independently replaced with a hydrocarbon group having 1 to 20 carbon atoms or a hydroxyalkyl group (e.g., a hydroxymethyl group, a 1-hydroxyethyl group, and a 2-hydroxyethyl group). The hydrocarbon group having 1 to 20 carbon atoms preferably has 1 to 15 carbon atoms, and more preferably 2 to 10 carbon atoms. The hydrocarbon group may be linear or branched.

Specific examples of the monomer represented by formula (a1) include (meth)acrylic acid, allyl amine, maleic anhydride, styrene, and the like; as well as (meth)acrylic esters, such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, hexyl (meth)acrylate, cyclohexyl (meth)acrylate, n-octyl (meth)acrylate, 2-methoxy(meth)acrylate, tetrahydrofurfuryl (meth)acrylate, 2-phenylethyl (meth)acrylate, 4-hydroxybutyl (meth)acrylate, 2-methoxy(meth)acrylate, tetrahydrofurfuryl (meth)acrylate, 2-phenylethyl (meth)acrylate, hydroxymethyl (meth)acrylate, phenoxyethyl (meth)acrylate, 2-hydroxyethyl (meth)acrylate, ethoxy-diethylene glycol (meth)acrylate, methoxy-triethylene glycol (meth)acrylate, and methoxy-polyethylene glycol (meth)acrylate; and (meth)acrylamide compounds, such as (meth)acrylamide, N, N-dimethyl (meth)acrylamide, N, N-diethylacrylamide, N-isopropyl (meth)acrylamide, 2-hydroxyethyl (meth)acrylamide, and N-hydroxymethyl (meth)acrylamide. These monomers may be used singly or in a combination of two or more.

Among the compounds represented by formula (a1), the third polymerizable monomer is preferably (meth)acrylic acid, a (meth)acrylic acid ester, (meth)acrylamide, or a derivative thereof.

The guest polymer can be formed by a polymerization reaction between the polymerizable monomer having a guest group and the third polymerizable monomer. Accordingly, the guest polymer has the polymerizable monomer unit having a guest group and the third monomer unit.

In the guest polymer, the content ratio of the guest groups in all of its structural units is preferably 0.1 mol % or more, more preferably 0.3 mol % or more, even more preferably 0.5 mol % or more, and particularly preferably 1 mol % or more. Further, in crosslinked structure A, the content ratio of the guest groups in all of its structural units is preferably 40 mol % or less, more preferably 20 mol % or less, even more preferably 10 mol % or less, and particularly preferably 5 mol % or less.

Since the polymer is formed by polymerizing the monomer mixture, in the present invention, the content ratio of each structural unit in the polymer can be considered to be the same as the molar ratio of the ratio of each polymerizable monomer used during polymerization.

### First Linear Polymer

The first linear polymer may be a linear polymer capable of penetrating the ring of the host group. In this respect, the first linear polymer is preferably a vinyl polymer, particularly preferably a polymer obtained by radical polymerization, and more preferably a polymer of one or more selected from the group consisting of (meth)acrylic acid, methyl (meth)acrylate, ethyl (meth)acrylate, propyl (meth)acrylate, (meth)acrylamide, and N, N-dimethyl (meth)acrylamide.

Other examples of the first linear polymer include condensation macromolecular compounds and polycondensation macromolecular compounds, such as epoxy resins, polycarbonate resins, polyamide resins, polyester resins, polyurethane resins, and urea resins. Specific examples include polyurethane having structural units derived from a chain-like diol compound and a chain-like diisocyanate compound.

The first linear polymer may also have, in its polymer chain, monomer unit S having a size that does not allow it to penetrate the ring of the host group. In this case, monomer unit S acts as a so-called stopper and can prevent the first linear polymer from falling off from the host group. As a result, the mechanical properties of the composite material are significantly improved, and the material tends to be tough.

The polymerizable monomer for forming monomer unit S is not particularly limited as long as it has a size that does not allow it to penetrate the ring of the host group. Examples include (meth)acrylic acid esters in which the group bonded to the ester oxygen has 4 or more and 30 or less carbon atoms, styrene, and N-substituted (meth)acrylamides having an alkyl group having 2 to 30 carbon atoms. Examples of (meth)acrylic acid esters in which the group bonded to the ester oxygen has 4 or more and 30 or less carbon atoms include (meth)acrylic acid alkyl esters having an alkyl group with a linear, branched, or cyclic structure. The alkyl group preferably has 4 or more and 20 or less carbon atoms, and more preferably 5 or more and 14 or less carbon atoms.

Examples of the polymerizable monomer for forming monomer unit S include n-butyl (meth)acrylate, i-butyl (meth)acrylate, t-butyl (meth)acrylate, n-heptyl (meth)acrylate, n-hexyl (meth)acrylate, and cyclohexyl (meth)acrylate.

Monomer unit S is preferably contained in an amount of 0 to 10 mol %, and more preferably 0 to 5 mol %, in the first linear polymer.

### Crosslinked Structure

In the composite material of the present invention, as described above, the crosslinked structure is formed such that the polymer component is crosslinked with cyclic molecular multimer C. In particular, the crosslinked structure is easily formed when the polymer component contains the guest polymer and/or the first linear polymer.

When the polymer component contains the guest polymer, the composite material of the present invention may contain a crosslinked structure formed such that at least one host group in the cyclic molecular multimer forms a clathrate complex together with the guest group in the guest polymer, and the other host group forms a clathrate complex together with a guest group in another guest polymer. Such a crosslinked structure is referred to below as “crosslinked structure A.”

Further, when the polymer component contains the first linear polymer, the composite material of the present invention may contain a crosslinked structure formed such that the linear polymer penetrates at least one host group in the cyclic molecular multimer, and another linear polymer penetrates the other host group. Such a crosslinked structure is referred to below as “crosslinked structure B.”

### Crosslinked Structure A

Crosslinked structure A has a structure formed such that the guest polymers are crosslinked with cyclic molecular multimer C.

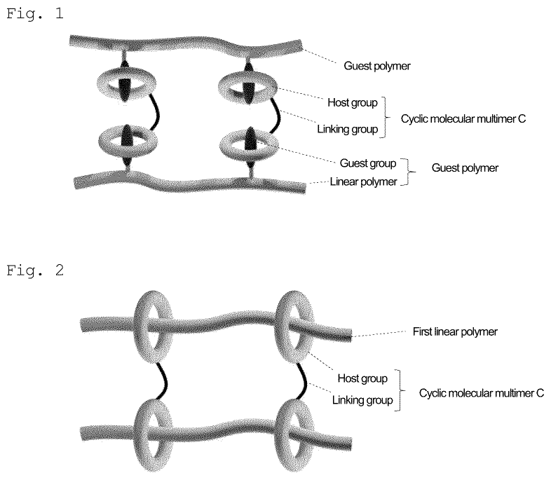

FIG. 1 is a schematic diagram schematically showing the structure of crosslinked structure A.

As can be seen from FIG. 1, cyclic molecular multimer C can function as a crosslinking agent that crosslinks the guest polymers together. In the composite material shown in FIG. 1, one host group of cyclic molecular multimer C includes the guest group of a guest polymer (so-called host-guest interaction occurs). The other host group of cyclic molecular multimer C includes the guest group of another guest polymer. As a result, crosslinked structure A is formed. Cyclic molecular multimer C can crosslink a certain guest polymer with another guest polymer different from the certain guest polymer. Crosslinked structure A is formed by host-guest interaction; that is, a crosslinked structure is formed by a reversible bond. Furthermore, the composite material containing crosslinked structure A has host-guest interaction, and therefore can have self-restorability.

The composite material containing crosslinked structure A has, for example, significantly improved mechanical properties compared to the guest polymer alone (i.e., non-crosslinked guest polymer), and particularly has a significantly improved fracture energy compared to the guest polymer alone. Therefore, the composite material containing crosslinked structure A is a tough material.

In crosslinked structure A, the content ratio of cyclic molecular multimer C and the guest polymers is not particularly limited. For example, the content ratio of cyclic molecular multimer C is preferably 0.5 to 40 mass %, more preferably 2 to 20 mass %, and even more preferably 5 to 10 mass %, based on the total mass of cyclic molecular multimer C and the guest polymers.

In crosslinked structure A, preferable examples of combinations of a host group and a guest group are such that when the host group is derived from an α-cyclodextrin derivative, the guest group is preferably at least one member selected from the group consisting of octyl and dodecyl; when the host group is derived from a β-cyclodextrin derivative, the guest group is preferably at least one member selected from the group consisting of adamantyl and isobornyl; and when the host group is derived from a γ-cyclodextrin derivative, the guest group is preferably at least one member selected from the group consisting of octyl, dodecyl, cyclododecyl, and adamantyl.

When the composite material of the present invention contains crosslinked structure A, the polymer component may contain a polymer other than the guest polymer, or the polymer component may consist of the guest polymer.

### Crosslinked Structure B

Crosslinked structure B has a structure formed such that the first linear polymers are crosslinked with cyclic molecular multimer C.

FIG. 2 is a schematic diagram schematically showing the structure of crosslinked structure B.

As can be seen from FIG. 2, cyclic molecular multimer C can function as a crosslinking agent that crosslinks the guest polymers together. In the composite material shown in FIG. 2, a first linear polymer penetrates the ring of one host group of cyclic molecular multimer C. Another first linear polymer penetrates the other host group of cyclic molecular multimer C. As a result, crosslinked structure B is formed. Cyclic molecular multimer C can crosslink a certain first linear polymer with another first linear polymer different from the certain first linear polymer. Crosslinked structure B is formed such that the first linear polymer penetrates the ring of the host group; that is, a movable crosslinked structure is formed.

The composite material containing crosslinked structure B has, for example, significantly improved mechanical properties compared to the first linear polymer alone, and particularly has a significantly improved fracture energy compared to the first linear polymer alone. Therefore, the composite material containing crosslinked structure B is a tough material.

The content ratio of cyclic molecular multimer C and the first linear polymers in crosslinked structure B is not particularly limited. For example, the content ratio of cyclic molecular multimer C is preferably 0.5 to 40 mass %, more preferably 2 to 20 mass %, and even more preferably 5 to 10 mass %, based on the total mass of cyclic molecular multimer C and the first linear polymers.

When the composite material of the present invention contains crosslinked structure B, the polymer component may also contain a second linear polymer. In this case, the second linear polymer can also penetrate the network of crosslinked structure B. This increases the compatibility between the first linear polymer and the second linear polymer, and the composite material particularly has excellent mechanical strength and tends to be a tougher material. The second linear polymer is preferably linear when it penetrates the network of the crosslinked polymer.

The type of second linear polymer is not particularly limited as long as it can penetrate the network of crosslinked structure B, and examples include the same types as those of the first linear polymer. In crosslinked structure B, the first linear polymer and the second linear polymer may be the same or different. The second linear polymer may also contain monomer unit S, as with the first linear polymer.

When the composite material of the present invention contain crosslinked structure B, the polymer component may contain a polymer other than the first linear polymer and the second linear polymer, or the polymer component may consist of the first linear polymer, or the polymer component may consist of the first linear polymer and the second linear polymer.

### Composite Material

The composite material of the present invention is a macromolecular composite material containing cyclic molecular multimer C and a polymer component. The composite material of the present invention contains, for example, crosslinked structure A or B described above, which makes the composite material tough. The composite material of the present invention may contain both crosslinked structures A and B.

The composite material of the present invention may contain other components in addition to cyclic molecular multimer C and the polymer component as long as the effects of the present invention are not impaired.

The shape of the macromolecular composite material of the present invention is not particularly limited, and may be, for example, a molded product such as a film, a sheet, a plate, or a block, or may be in the form of particles, fibers, granules, or pellets.

The macromolecular composite material of the present invention is configured as described above, and is thus excellent in mechanical strength and is likely to be a tough material. Specifically, the macromolecular composite material of the present invention tends to have high fracture energy and Young's modulus, and these are well balanced; thus, the macromolecular composite material becomes a tough material.

### 2. Method for Producing Macromolecular Composite Material

The method for producing the macromolecular composite material of the present invention is not particularly limited. For example, the macromolecular composite material of the present invention can be produced by a method comprising the following step 1:
Step 1 of obtaining a composite material from a mixture of a cyclic molecular multimer and a polymer component.

The macromolecular composite material of the present invention can also be produced by a method comprising the following step 2:
Step 2 of subjecting a polymerizable monomer to a polymerization reaction in the presence of the cyclic molecular multimer to produce a polymer component, thereby obtaining the composite material.

The composite material containing crosslinked structure A can be produced by a production method comprising either of step 1 and step 2 described above. Further, the composite material containing crosslinked structure B can be produced by a production method comprising either of step 1 and step 2 described above. For example, when the production method of the present invention comprises step 1, crosslinked structure A tends to be formed, and this method is thus suitable for producing a composite material containing crosslinked structure A. When the production method of the present invention comprises step 2, crosslinked structure B tends to be formed, and this method is thus suitable for producing a composite material containing crosslinked structure B.

### Step 1

The cyclic molecular multimer used in step 1 is the same as cyclic molecular multimer C described above. The cyclic molecular multimer used as a starting material in step 1 is preferably such that no polymer or guest group penetrates or is included in the ring of at least one host group of the cyclic molecule, and more preferably such that no polymer or guest group penetrates or is included in the rings of all the host groups.

The polymer component used in step 1 is the same as the polymer component for forming crosslinked structure A described above. Therefore, the polymer component used in step 1 contains the guest polymer.

In step 1, the method for preparing a mixture of cyclic molecular multimer C and a guest polymer is not particularly limited. For example, the mixture can be obtained by mixing cyclic molecular multimer C and the guest polymer in an organic solvent. Therefore, the mixture can be a solution or a dispersion, and preferably a solution. The mixing means is also not particularly limited. For example, known mixing means can be widely used.

Examples of the organic solvent include hydrocarbon solvents, such as benzene, toluene, and xylene; ketone solvents, such as acetone, methyl ethyl ketone, and isophorone; alcohol solvents, such as tert-butyl alcohol, benzyl alcohol, phenoxyethanol, and phenyl propylene glycol; halogenated hydrocarbon solvents, such as methylene chloride and chloroform; ether solvents, such as 1,2-dimethoxyethane, tetrahydrofuran, 1,4-dioxane, and anisole; ester solvents, such as ethyl acetate, propyl acetate, butyl acetate, ethyl carbitol acetate, and butyl carbitol acetate; amide solvents, such as N, N-dimethylformamide and N, N-dimethylacetamide; and carbonate solvents, such as dimethyl carbonate, diethyl carbonate, and propylene carbonate.

In step 1, the method of obtaining a composite material from the mixture is also not particularly limited. For example, when the mixture is a solution, a solid composite material can be formed by evaporating the organic solvent from the mixture. For example, a film-like composite material can be formed by a casting method using the mixture. The conditions for the casting method are also not particularly limited, and known casting methods can be widely used.

Crosslinked structure A is formed in step 1. That is, cyclic molecular multimer C is mixed with a guest polymer to form a clathrate complex between the host group in cyclic molecular multimer C and the guest group in the guest polymer, thereby forming crosslinked structure A.

Crosslinked structure A obtained in step 1 can be used as a composite material, or crosslinked structure A obtained in step 1 can be suitably combined with other materials to form a composite material.

### Step 2

The cyclic molecular multimer used in step 2 is the same as cyclic molecular multimer C described above. The cyclic molecular multimer used as a starting material in step 2 is preferably such that no polymer or guest group penetrates or is included in the ring of at least one host group of the cyclic molecule, and more preferably such that no polymer or guest group penetrates or is included in the rings of all the host groups.

The polymerizable monomer used in step 2 is a polymerizable monomer for forming a polymer component. Therefore, the polymerizable monomer used in step 2 is a polymerizable monomer for producing a first linear polymer.

The polymerizable monomer for producing a first linear polymer may be one or more selected from the group consisting of (meth)acrylic acid, methyl (meth)acrylate, ethyl (meth)acrylate, propyl (meth)acrylate, (meth)acrylamide, and N, N-dimethyl (meth)acrylamide.

In step 2, the polymerization reaction of a polymerizable monomer is performed in the presence of a cyclic molecular multimer. The polymerization reaction is not particularly limited. For example, known polymerization reaction conditions can be widely used in the present invention. For example, the polymerization reaction can be carried out on a mixture of a cyclic molecular multimer and a polymerizable monomer in the presence of a polymerization initiator.

The polymerization in step 2 can be carried out using a solvent or without a solvent (e.g., bulk polymerization).

Crosslinked structure B is formed in step 2 described above. That is, a polymerization reaction of the polymerizable monomer occurs in the presence of cyclic molecular multimer C, and the growing polymer chain (first linear polymer chain) penetrates the host groups in cyclic molecular multimer C, thereby forming movable crosslinked structure B as shown in FIG. 2.

Crosslinked structure B obtained in step 2 can be used as a composite material, or crosslinked structure B obtained in step 2 can be suitably combined with other materials to form a composite material.

Further, the second linear polymer described above can be produced by performing the polymerization reaction of a polymerizable monomer for producing the second linear polymer in the presence of crosslinked structure B. The second linear polymer can penetrate the network of crosslinked structure B.

When using a clathrate compound of cyclic molecular multimer C and a guest group-containing monomer unit, crosslinked structure A can be produced. For example, crosslinked structure A can be produced by performing the polymerization reaction of a third polymerizable monomer in the presence of this clathrate compound.

As described above, the composite material of the present invention can be produced in a simple manner by the production method comprising step 1 or step 2.

### 3. Crosslinking Agent

The present invention also includes a crosslinking agent for forming a crosslinked structure of a polymer. The crosslinking agent contains cyclic molecular multimer C. That is, the crosslinking agent contains a cyclic molecular multimer, the cyclic molecular multimer has at least two host groups, the host groups are each a group formed by removing one hydrogen atom or hydroxy group from a cyclodextrin or a cyclodextrin derivative, and the cyclic molecular multimer has a structure formed such that the at least two host groups are linked via a divalent or higher group having a chain structure.

Various crosslinked structures can be formed by using the crosslinking agent of the present invention, which is particularly suitable for use in producing crosslinked structures A and B described above. Therefore, the crosslinking agent of the present invention allows the production of composite materials with excellent mechanical properties.

### EXAMPLES

Below, the present invention is described in more detail with reference to Examples. However, the present invention is not limited to the embodiments of the Examples.

### Production Example 1: Acrylated Cyclodextrin

20 g of 6-acrylamide-β-cyclodextrin (βCD-AAm) was dissolved in 300 mL of pyridine, and 170.133 g of acetic anhydride was added, followed by stirring at 55° C. for 12 hours or more. Thereafter, 50 mL of methanol was added thereto for quenching, and the content was concentrated to 200 mL with an evaporator. The obtained concentrated solution was added dropwise to 2000 mL of water, and the precipitate was collected. The precipitate was dissolved in 200 mL of acetone, the resultant solution was added dropwise to 2000 mL of water, and the formed precipitate was collected. The precipitate was dried under reduced pressure to obtain a solid content. From the results of mass spectrum and NMR spectrum of this solid content, it was found that a cyclodextrin compound having a structure formed such that the hydrogen atoms of all the hydroxy groups contained in βCD-AAm were replaced with acetyl groups was obtained. This cyclodextrin compound was named “ACCD-S.”

### Production Example 2-1

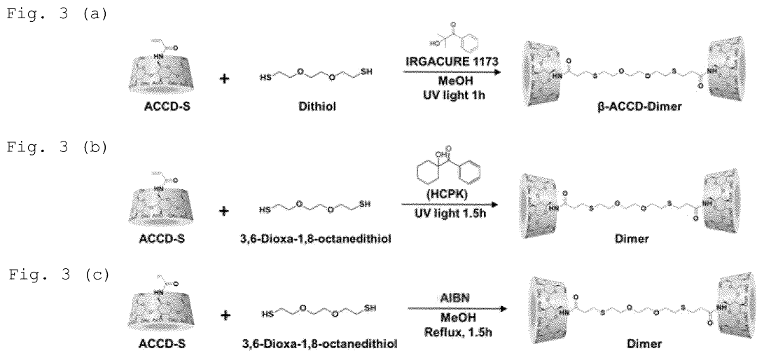

According to the scheme shown in FIG. 3 (a), cyclic molecular multimer C was prepared by a thiol-ene reaction between acrylated cyclodextrin and a dithio compound having thiol groups at both ends. Specifically, ACCD-S (203 mg, 0.10 mmol) obtained in Production Example 1, 3,6-dioxa-1,8-octanedithiol (9.1 mg, 0.050 mmol), and IRGACURE 1173 (registered trademark) (2.0 mg, 0.010 mmol) were dissolved in 1 mL of methanol to obtain a solution. The solution was bubbled with nitrogen and then irradiated with ultraviolet rays (365 nm) for 1.5 hours, after which the methanol was distilled off, followed by drying under reduced pressure at 95° C. for 16 hours, thereby obtaining a white solid.

### Production Example 2-2

According to the scheme shown in FIG. 3 (b), cyclic molecular multimer C was prepared by a thiol-ene reaction between acrylated cyclodextrin and a dithio compound having thiol groups at both ends. Specifically, ACCD-S (11.0 g, 5.42 mmol) obtained in Production Example 1, 3,6-dioxa-1,8-octanedithiol (0.44 mL, 2.71 mmol), and IRGACURE 184 (registered trademark) (110 mg, 0.5 mmol) were dissolved in 55.0 mL of methanol to obtain a solution. The solution was irradiated with ultraviolet rays (365 nm) for 1.5 hours, after which the methanol was distilled off, followed by drying under reduced pressure at 95° C. for 16 hours, thereby obtaining 10.8 g (yield: 94.1%) of a white solid.

### Production Example 2-3

According to the scheme shown in FIG. 3 (c), cyclic molecular multimer C was prepared by a thiol-ene reaction between acrylated cyclodextrin and a dithio compound having thiol groups at both ends. Specifically, ACCD-S (38.0 g, 18.7 mmol) obtained in Production Example 1, 3,6-dioxa-1,8-octanedithiol (1.7 g, 9.36 mmol), and AIBN (308 mg, 1.87 mmol) were dissolved in 185 mL of methanol to obtain a solution. The solution was heated under reflux for 2 hours, after which the methanol was distilled off, followed by drying under reduced pressure at 95° C. for 16 hours, thereby obtaining 39.6 g (yield: 100%) of a white solid.

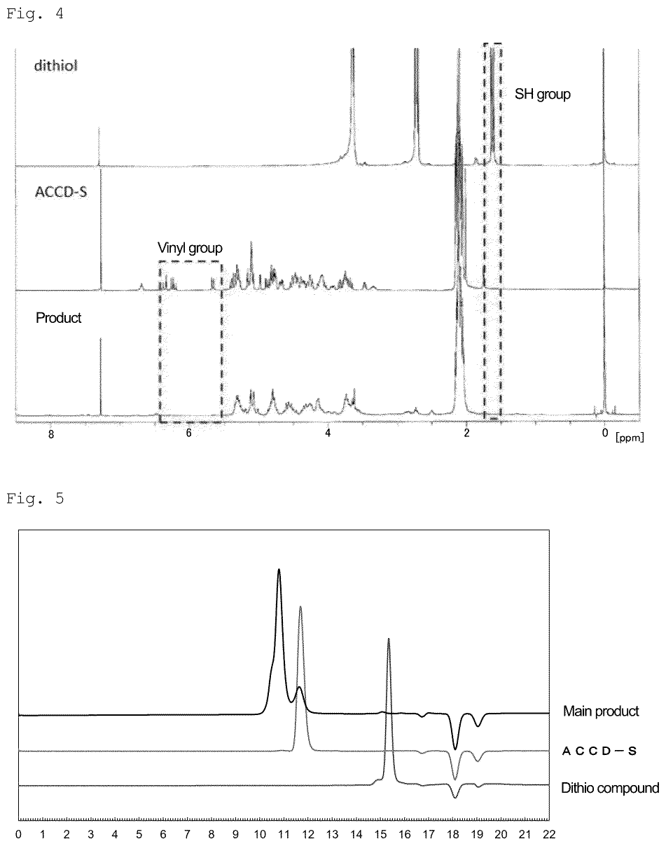

FIG. 4 is the 1H-NMR spectrum of the white solid (main product) obtained in Production Example 2 (for reference, the spectra of the starting materials, ACCD-S and the dithio compound, are also shown). From this figure, it was confirmed that target cyclic molecular multimer C (the compound represented by formula (1a)) was produced. Furthermore, the disappearance of ACCD-S and the dithio compound was confirmed from the results of TLC (not shown) and NMR immediately after the thiol-ene reaction, and the quantitative progress of the reaction was confirmed. It was found that the NMR integrated intensity ratio also agreed well with the assumed structure.

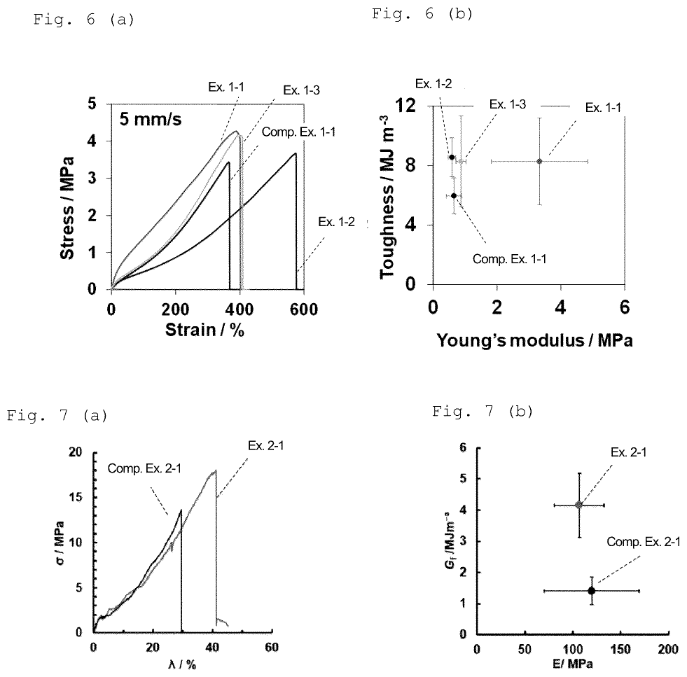

FIG. 5 shows the results of GPC measurement of the white solid (main product) obtained in Production Example 2 (for reference, the results of GPC measurement of the starting materials, ACCD-S and the dithio compound, are also shown). In this GPC measurement, a GPC device produced by JASCO Corporation was used, the column was “Shodex KF-602.5, 602, 601 tandem,” the solvent was THF (0.5 mL/min), and the detector was RI. From the GPC measurement, a large peak (10.8 min) of the hydrodynamic radius corresponding to target cyclic molecular multimer C was confirmed. It was confirmed that only small amounts of ACCD-S and ACCD-S with a crushed vinyl group were detected (11.7 min), and that the dithio compound (15.6 min) had almost disappeared. From the RI intensity, 90% or more of the product obtained in Production Example 2 was target cyclic molecular multimer C (the compound represented by formula (1a)). Cyclic molecular multimer C is represented by formula (1a), wherein the linking group R¹ is —NCO—(CH₂)₂—S—(CH₂)₂—O—(CH₂)₂—O—(CH₂)₂—S—(CH₂)₂—CON—.

### Production Example 3: Guest Polymer

A mixture was obtained by mixing N-(1-adamantyl) acrylamide (Ad-Aam) as a guest group-containing monomer unit and ethyl acrylate as a third polymerizable monomer at a molar ratio of 3:97. To this mixture, IRGACURE 184 (registered trademark) as a polymerization initiator was added in an amount of 0.1 mol % relative to the polymerizable monomer, and the mixture was irradiated with ultraviolet rays (365 nm) and then vacuum-dried at 60° C. for 20 hours to obtain a guest polymer.

### Example 1-1: Crosslinked Structure A

A mixture of a guest polymer and cyclic molecular multimer C obtained in Production Example 2 was prepared so that the content ratio of cyclic molecular multimer C obtained in Production Example 2 was 5 mass %. The mixture was added to acetone to a concentration of 1 mass %, followed by stirring at 25° C. for 4 hours, thereby obtaining a solution. The solution was cast into a Teflon (registered trademark) petri dish, allowed to stand at 25° C. for 12 hours, and then allowed to stand in an atmosphere of 100° C. for 12 hours, thereby obtaining a film. The obtained film was covered with a spacer of 4 cm×4 cm×0.2 mm and pressed at 2 kN for 4 minutes in an atmosphere of 100° C., thereby obtaining a composite material.

### Example 1-2: Crosslinked Structure A

A composite material was obtained in the same manner as in Example 1-1, except that the mixture was prepared so that the content ratio of cyclic molecular multimer C obtained in Production Example 2 was 10 mass %.

### Example 1-3: Crosslinked Structure A

A composite material was obtained in the same manner as in Example 1-1, except that the mixture was prepared so that the content ratio of cyclic molecular multimer C obtained in Production Example 2 was 20 mass %.

### Comparative Example 1-1

A film was formed in the same manner as in Example 1-1 using only the guest polymer obtained in Production Example 3 without using cyclic molecular multimer C.

### Example 2-1: Crosslinked Structure B

A mixture was obtained by mixing cyclic molecular multimer C obtained in Production Example 2 and methyl methacrylate (starting material for the first linear polymer) so that the content ratio of cyclic molecular multimer C was 10 mass %. The mixture was irradiated with ultrasonic waves for 1 hour to promote complex formation, and a solution was obtained. 0.5 mol % of Omnirad 184 (registered trademark) was added to the solution, and after ultrasonic irradiation for 3 minutes, the solution was placed in a mold and irradiated with ultraviolet rays using a mercury lamp for 60 minutes. The solid matter obtained by this irradiation was dried in a vacuum oven at 100° C. to obtain a composite material.

### Comparative Example 2-1

A material was obtained in the same manner as in Example 2-1, except that cyclic molecular multimer C was not used.

### Example 3-1: Crosslinked Structure B

A composite material was obtained in the same manner as in Example 2-1, except that methyl methacrylate was changed to ethyl acrylate, the mixture was prepared so that the content ratio of cyclic molecular multimer C was 0.5 mass %, and the amount of Omnirad 184 (registered trademark) used was changed to 1 mol %.

### Comparative Example 3-1

A material was obtained in the same manner as in Example 3-1, except that cyclic molecular multimer C was not used.

### Example 4-1: Crosslinked Structure B

A composite material was obtained in the same manner as in Example 2-1, except that methyl methacrylate was changed to methyl acrylate, the mixture was prepared so that the content ratio of cyclic molecular multimer C was 0.5 mass %, and the amount of Omnirad 184 (registered trademark) used was changed to 1 mol %.

### Example 4-2: Crosslinked Structure B

A composite material was obtained in the same manner as in Example 4-1, except that the mixture was prepared so that the content ratio of cyclic molecular multimer C was 1 mass %.

### Example 4-3: Crosslinked Structure B

A composite material was obtained in the same manner as in Example 4-1, except that the mixture was prepared so that the content ratio of cyclic molecular multimer C was 3 mass %.

### Comparative Example 4-1

A material was obtained in the same manner as in Example 4-1, except that cyclic molecular multimer C was not used.

### Example 5-1: Crosslinked Structure B

A mixture was obtained by mixing cyclic molecular multimer C obtained in Production Example 2 and a mixed monomer of methyl acrylate and hexyl acrylate (starting material for the first linear polymer, containing 1 mol % hexyl acrylate) so that the content ratio of cyclic molecular multimer C was 0.5 mass %. The mixture was irradiated with ultrasonic waves for 1 hour to promote complex formation, and a solution was obtained. 1 mol % of Omnirad 184 (registered trademark) was added to the solution, and after ultrasonic irradiation for 3 minutes, the solution was placed in a mold and irradiated with ultraviolet rays using a mercury lamp for 30 minutes. The solid matter obtained by this irradiation was dried in a vacuum oven at 60° C. to obtain a composite material.

### Comparative Example 5-1

A material was obtained in the same manner as in Example 5-1, except that cyclic molecular multimer C was not used.

### Young's Modulus and Fracture Energy of Composite Material

The mechanical properties of the composite materials were evaluated by observing the rupture point of each macromolecular material through a tensile test (stroke-test force curve) (Autograph AGX-plus produced by Shimadzu Corporation). With this rupture point taken as the final point, the maximum stress applied until the final point was determined to be the rupture stress of the macromolecular material. This tensile test was performed with the bottom end of the sheet-like macromolecular composite material fixed, and the upper end pulled at a specific tension rate (Example 1 series: 5 mm/sec, Example 2 series: 0.1 mm/sec, and series of Examples 3 to 5:1 mm/sec) (upward operation). From this measurement, the Young's modulus and fracture energy of the macromolecular material were calculated.

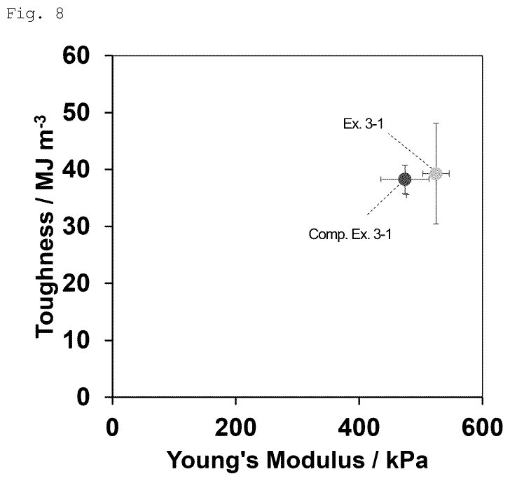

FIG. 6 shows the stress-strain curves (FIG. 6 (a)) and the results of Young's modulus and fracture energy (FIG. 6 (b)) of the composite materials obtained in Examples 1-1, 1-2, and 1-3. From this figure, it was confirmed that the composite materials obtained in Examples 1-1, 1-2, and 1-3 had improved Young's modulus and fracture energy compared to the guest polymer alone (Comparative Example 1-1), and were thus tough materials.

FIG. 7 shows the stress-strain curves and the results of Young's modulus and fracture energy of the composite materials obtained in Example 2-1 and Comparative Example 2-1. From this figure, it was revealed that the composite material obtained in Example 2-1 had improved Young's modulus and fracture energy compared to the methyl methacrylate homopolymer (Comparative Example 2-1), and was thus a tough material.

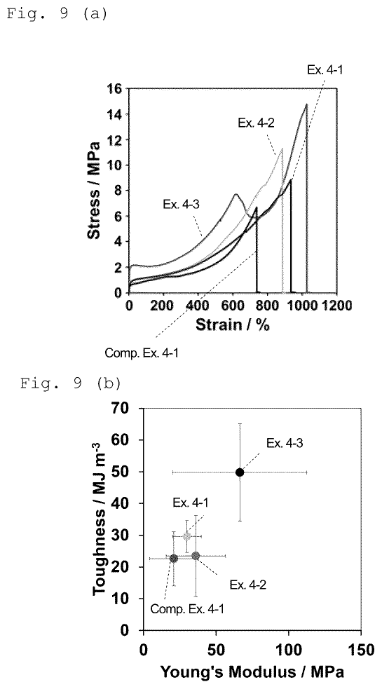

FIG. 8 shows the results of the Young's modulus of the composite materials obtained in Example 3-1 and Comparative Example 3-1. From this figure, it was confirmed that the composite material obtained in Example 3-1 had improved Young's modulus and fracture energy compared to the ethyl acrylate homopolymer (Comparative Example 3-1), and was thus a tough material.

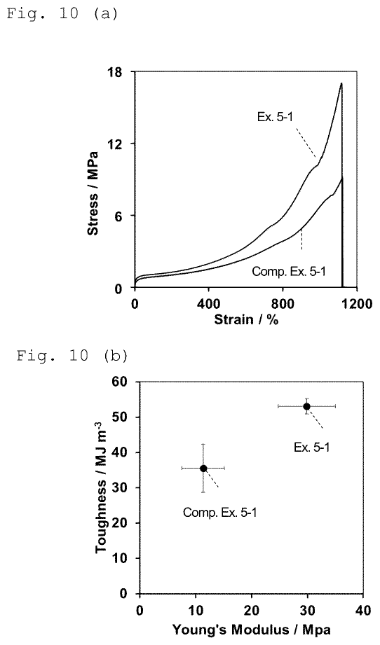

FIG. 9 shows the stress-strain curves (FIG. 9 (a)) and the results of Young's modulus and fracture energy of the composite materials obtained in Examples 4-1, 4-2, and 4-3 and Comparative Example 4-1. From this figure, it was confirmed that the composite materials obtained in Examples 4-1 to 4-3 had improved Young's modulus and fracture energy compared to the methyl acrylate homopolymer (Comparative Example 4-1), and were thus tough materials.

FIG. 10 shows the stress-strain curves (FIG. 9 (a)) and the results of Young's modulus and fracture energy of the composite materials obtained in Example 5-1 and Comparative Example 5-1. From this figure, it was confirmed that the composite material obtained in Example 5-1 had improved Young's modulus and fracture energy compared to the methyl acrylate/hexyl acrylate polymer (Comparative Example 5-1), and was thus a tough material. As for the composite material of Example 5-1, it is presumed that the hexyl acrylate unit in the first linear polymer functioned as a stopper, which enabled further toughening of the composite material to be achieved.

1. A composite material comprising a cyclic molecular multimer having at least two host groups, and a polymer component,
the host groups each being a group formed by removing one hydrogen atom or hydroxy group from a cyclodextrin or a cyclodextrin derivative, and
the cyclic molecular multimer having a structure formed such that the at least two host groups are linked via a divalent or higher group having a chain structure.

2. The composite material according to claim 1, wherein the cyclodextrin derivative has a structure formed such that a hydrogen atom of at least one hydroxy group contained in a cyclodextrin is replaced with at least one group selected from the group consisting of a hydrocarbon group, an acyl group, and —CONHR wherein R represents an alkyl group.

3. The composite material according to claim 1, comprising a crosslinked structure formed such that the polymer component is crosslinked with the cyclic molecular multimer.

4. The composite material according to claim 1, wherein the polymer component comprises a guest polymer having at least one guest group on a polymer side chain, and the composite material comprises a crosslinked structure formed such that at least one host group in the cyclic molecular multimer forms a clathrate complex together with the guest group in the guest polymer, and the other host group forms a clathrate complex together with a guest group in another guest polymer.

5. The composite material according to claim 1, wherein the polymer component comprises a first linear polymer, and the composite material comprises a crosslinked structure formed such that the first linear polymer penetrates at least one host group in the cyclic molecular multimer, and another first linear polymer penetrates the other host group.

6. The composite material according to claim 5, wherein the polymer component comprises a second linear polymer, and the second linear polymer penetrates a network of the crosslinked structure.

7. A crosslinking agent for forming a crosslinked structure of a polymer,
the crosslinking agent comprising a cyclic molecular multimer,
the cyclic molecular multimer having at least two host groups,
the host groups each being a group formed by removing one hydrogen atom or hydroxy group from a cyclodextrin or a cyclodextrin derivative, and
the cyclic molecular multimer having a structure formed such that the at least two host groups are linked via a divalent or higher group having a chain structure.

8. The crosslinking agent according to claim 7, wherein the cyclodextrin derivative has a structure formed such that a hydrogen atom of at least one hydroxy group contained in a cyclodextrin is replaced with at least one group selected from the group consisting of a hydrocarbon group, an acyl group, and —CONHR wherein R represents an alkyl group.

9. A method for producing the composite material according to claim 1, comprising obtaining the composite material from a mixture of the cyclic molecular multimer and a polymer component.

10. A method for producing the composite material according to claim 1, comprising performing a polymerization reaction of a polymerizable monomer in the presence of the cyclic molecular multimer to produce a polymer component, thereby obtaining the composite material.

11. The composite material according to claim 2, comprising a crosslinked structure formed such that the polymer component is crosslinked with the cyclic molecular multimer.

12. The composite material according to claim 2, wherein the polymer component comprises a guest polymer having at least one guest group on a polymer side chain, and the composite material comprises a crosslinked structure formed such that at least one host group in the cyclic molecular multimer forms a clathrate complex together with the guest group in the guest polymer, and the other host group forms a clathrate complex together with a guest group in another guest polymer.

13. The composite material according to claim 2, wherein the polymer component comprises a first linear polymer, and the composite material comprises a crosslinked structure formed such that the first linear polymer penetrates at least one host group in the cyclic molecular multimer, and another first linear polymer penetrates the other host group.

14. The composite material according to claim 13, wherein the polymer component comprises a second linear polymer, and the second linear polymer penetrates a network of the crosslinked structure.

15. A method for producing the composite material according to claim 2, comprising obtaining the composite material from a mixture of the cyclic molecular multimer and a polymer component.

16. A method for producing the composite material according to claim 2, comprising performing a polymerization reaction of a polymerizable monomer in the presence of the cyclic molecular multimer to produce a polymer component, thereby obtaining the composite material.
